(19) United States
(12) Patent Application Publication
(10) Pub. No.: US 2009/0040484 A1
(43) Pub. Date: Feb. 12, 2009

(54) EXPOSURE EQUIPMENT, EXPOSURE METHOD, AND MANUFACTURING METHOD FOR A SEMICONDUCTOR DEVICE

(75) Inventor: Shouichirou HAYASHI, Kumamoto-shi (JP)

Correspondence Address: YOUNG & THOMPSON, 209 Madison Street, Suite 500, ALEXANDRIA, VA, 22314, US

(73) Assignee: NEC ELECTRONICS CORPORATION, Kanagawa (JP)

(21) Appl. No.: 12/186,761

(22) Filed: Aug. 6, 2008

(30) Foreign Application Priority Data
Aug. 8, 2007 (JP) 2007-206171

(51) Int. Cl. G03B 27/68

(52) U.S. Cl. 355/52

(57) ABSTRACT

Provided is an exposure equipment having high resolution even when a reticle is inclined. The exposure equipment includes: an optical system for projecting on a wafer (130), a pattern formed on a surface of a reticle (101); a determining section for determining a tilt angle of the reticle (101) with respect to a plane perpendicular to an optical axis direction of the optical system; and an adjusting section for adjusting a position of the wafer (130) based on the tilt angle determined by the determining section.

### BACKGROUND OF THE INVENTION

1. Field of the Invention

The present invention relates to an exposure equipment, an exposure method, and a manufacturing method for a semiconductor device.

2. Description of the Related Art

JP 11-340125 A discloses a step-and-repeat exposure equipment. As shown in FIG. 10, in the exposure equipment described in JP 11-340125 A, a sample stage 11 is disposed on an XY stage 13 through Z driving sections 12A to 12C, and a wafer W is held on the sample stage 11 through a wafer holder 10 to transfer a pattern of a reticle R on the wafer W. Before exposure, tilt angles Itx and Ity of an image surface 22 of a projection optical system PL with respect to a running plane 14a of the XY stage 13 are determined. In the exposure, when the XY stage 13 is moved stepwise, for example, expansion and contraction amounts of the Z driving sections 12A to 12C are adjusted based on the tilt angle of the image surface 22 and the position of the XY stage 13 to correct the position in a Z direction and the tilt angle of a wafer W surface. After that, in an exposure position, a surface position of the wafer W surface is corrected such that the remaining defocus amount which is determined with an autofocus sensor (not shown) is set to 0.

In the method of determining the tilt angle of the image surface 22 of the projection optical system PL, a wafer having a satisfactory flatness is disposed on the wafer holder, focus positions are determined on five points of an exposed region, that is, the center point and four corner points thereof, and then, based on the determined values, the tilt angles Itx and Ity (not shown) of the image surface 22 are obtained.

JP 2003-142365 A discloses an exposure equipment for calculating reticle deformation amounts in a scanning direction of the reticle and a direction perpendicular thereto, by arranging on a reticle periodically a bar-like periodic pattern in a direction perpendicular to the scanning direction and a linear mark parallel to the scanning direction. The exposure equipment determines the reticle deformation amounts with a detector disposed outside an axis of a projection exposure optical system. Moreover, a main control system performs changes in relative displacement rate of a reticle stage driving section and a wafer stage, changes in intervals between lens elements within the projection optical system, and changes in pressure in a lens barrel through a pressure control section included in the projection optical system, whereby magnification components of imaging characteristics are corrected.

However, the technologies described in JP 11-340125 A and JP 2003-142365 A leave the following points to be improved.

With regard to the exposure equipment disclosed in JP 11-340125 A, when a foreign matter is stuck between the reticle and a reticle holder, and therefore the reticle is floating on the reticle holder, it is necessary to perform a troublesome procedure in which a wafer having a satisfactory flatness is disposed on the wafer holder to determine the tilt angle of the image surface. Besides, it is conceivable that the shape of the reticle is deformed at a time of developing an exposure operation or at a time of exchanging reticles due to the stuck foreign matter, so it is necessary to dispose a wafer having a satisfactory flatness on the wafer holder to determine the tilt angle of the image surface at each time of exposure or exchanging reticles. As a result, the exposure process itself is made complicated and troublesome, which causes the difficulty in attaining high resolution with ease.

With regard to the exposure equipment disclosed in JP 2003-142365 A, the bar-like periodic pattern and the linear mark are arranged on the reticle. Therefore, it is required to form the bar-like periodic pattern and the linear mark on the reticle, because a reticle deformation amount is not obtained with a reticle normally used, and it is difficult to attain excellent resolution.

### SUMMARY

The present invention provides an exposure equipment including: an optical system for projecting, on a wafer, a pattern formed on a surface of a reticle; a determining (detection) section for directly determining (detecting) a tilt angle of the reticle with respect to a plane perpendicular to an optical axis direction of the optical system; and an adjusting section for adjusting a position of the wafer based on the tilt angle determined by the determining section.

In the exposure equipment, the position of the wafer is adjusted based on the tilt angle determined by the determining section for directly determining the tilt angle of the reticle with respect to the plane perpendicular to the optical axis direction of the optical system. According to the exposure equipment having such a structure, it is possible to attain a pattern having high resolution with ease without complicating an exposure process, even when the reticle is inclined.

The present invention provides an exposure method including: projecting, on a wafer, a pattern formed on a surface of a reticle; determining a tilt angle of the reticle with respect to a plane perpendicular to an optical axis direction of an optical system; and adjusting a surface of the wafer to be parallel to the surface of the reticle, which is perpendicular to the optical axis direction of the optical system, based on the determined tilt angle.

In the exposure method, before exposure, the tilt angle of the reticle with respect to the plane perpendicular to the optical axis direction of the optical system is determined to adjust a position of the wafer surface based on the determined tilt angle. Therefore, even when the reticle is inclined, processes can be successively performed without exchanging wafers for the purpose of adjusting the focus, whereby a pattern having high resolution can be attained with ease.

The present invention provides a manufacturing method for a semiconductor device, the manufacturing method including forming a pattern on a wafer by using an exposure equipment including: an optical system for projecting, on a wafer, a pattern formed on a surface of a reticle; a determining section for determining a tilt angle of the reticle with respect to a plane perpendicular to an optical axis direction of the optical system; and an adjusting section for adjusting a position of the wafer based on the tilt angle determined by the determining section.

In the manufacturing method for a semiconductor device, the exposure equipment is used, with which the focus can be adjusted without complicating the exposure process even when the reticle is inclined, and a pattern having high resolution can be formed. Therefore, it is possible to improve the productivity of semiconductor devices.

Note that the respective sections of the present invention may be formed with any sections as long as they can realize functions thereof. For example, the respective sections may be realized as specific hardware for exerting a given function, a computer apparatus having a given function imparted by a computer program, a given function of a computer apparatus realized by a computer program, combinations arbitrarily selected therefrom, and the like.

Various constituents of the present invention need not to be independent of each other. It is also possible that a plurality of constituents are formed as one member, one constituent is formed of a plurality of members, a constituent is a portion of another constituent, a portion of a constituent overlaps with a portion of another constituent, and the like.

According to the present invention, even when a reticle is inclined, there are realized the exposure equipment, the exposure method, and the manufacturing method for a semiconductor device, which provide excellent resolution with ease.

### BRIEF DESCRIPTION OF THE DRAWINGS

In the accompanying drawings:

FIG. 1 is a sectional view showing an exposure equipment according to an embodiment of the present invention;

FIGS. 2A to 2D are views, showing a reticle placed on reticle holders of the exposure equipment according to the embodiment, in which FIGS. 2A and 2C are plan views of the reticle, and FIGS. 2B and 2D are sectional views thereof;

FIG. 3 is a plan view showing the reticle placed on the reticle holders of the exposure equipment according to the embodiment;

FIG. 4 is a conceptual view for explaining the reticle of the exposure equipment according to the embodiment;

FIG. 5 is another conceptual view for explaining the reticle of the exposure equipment according to the embodiment;

FIG. 6 is a conceptual view for explaining a determining method for a tilt angle of the reticle of the exposure equipment according to the embodiment;

FIG. 7 is another conceptual view for explaining the determining method for the tilt angle of the reticle of the exposure equipment according to the embodiment;

FIGS. 8A to 8C are conceptual views for explaining a calculating method for a floating amount of the reticle of the exposure equipment according to the embodiment;

FIGS. 9A and 9B are conceptual views for explaining the calculating method for the floating amount of the reticle of the exposure equipment according to the embodiment; and

FIG. 10 is a sectional view showing a conventional exposure equipment.

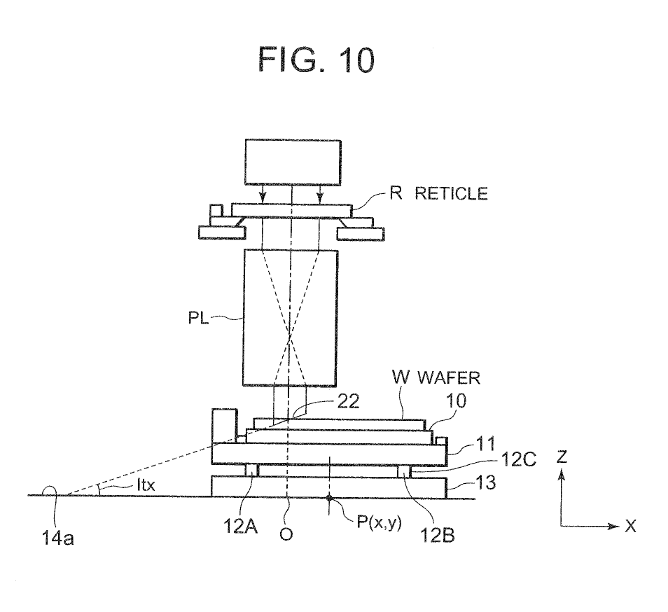

### DETAILED DESCRIPTION OF THE PREFERRED EMBODIMENT

Hereinafter, a detailed description is given of a preferred embodiment of an exposure equipment, an exposure method, and a manufacturing method for a semiconductor device according to the present invention, with reference to the drawings. For explanation of the drawings, the same reference symbols are given to the same constituents, and the explanation thereof is omitted. In the embodiment of the present invention, the explanation is made defining back-and-forth, right-and-left, and up-and-down directions. However, the directions are defined for convenience for the purpose of explaining relative relationships between constituents with ease, and therefore do not confine directions used at a time of production or application in a case of implementing the present invention.

### First Embodiment

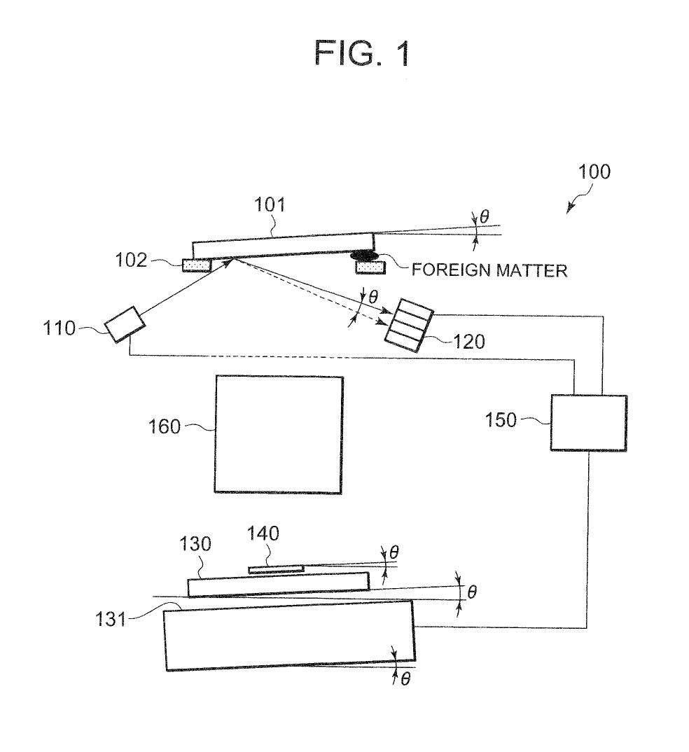

With reference to FIGS. 1 to 9, an exposure equipment according to a first embodiment of the present invention is described below.

The structure of an exposure equipment 100 is as follows.

FIG. 1 is a sectional view of an exposure equipment according to this embodiment. As shown in FIG. 1, the exposure equipment 100 of this embodiment includes an optical system (not shown) for projecting on a wafer 130 a pattern formed on a surface of a reticle 101, a light-emitting device 110, a light-receiving device 120, and a control device 150 each functioning as a determining section, a wafer stage 131 functioning as an adjusting section, the reticle 101 placed on reticle holders 102, and a reduction-projection lens 160.

In the exposure equipment 100, exposure light emitted from the optical system passes through the reticle 101 and the reduction-projection lens 160 to project on the wafer 130 (target of exposure) the pattern formed on the surface of the reticle 101, and an image surface 140 is formed on a surface of the wafer 130. The image surface 140 is the pattern that has been formed on the surface of the wafer 130. In FIG. 1, the wafer 130, the wafer stage 131, and the image surface 140 are shown separately for convenience.

Details are described below.

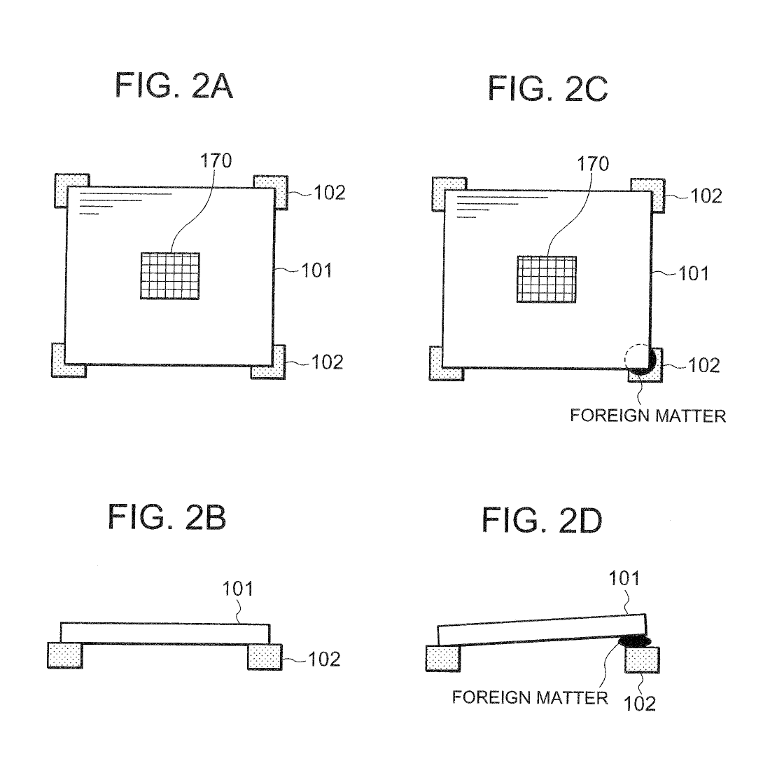

FIGS. 2A to 2D are views showing the reticle 101 placed on the reticle holders 102. FIGS. 2A and 2C are plan views of the reticle 101, and FIGS. 2B and 2D are sectional views thereof.

As shown in FIGS. 2A and 2B, the reticle 101 is placed on the reticle holders 102. The reticle 101 is square when seen in plan view, and respective vertexes of the reticle 101 are supported by the reticle holders 102. The reticle 101 is set on a plane perpendicular to an optical axis direction of the optical system, and a pattern 170 is formed on the surface of the reticle 101 (FIG. 2A).

As shown in FIGS. 2C and 2D, a foreign matter is stuck between the reticle 101 and one of the reticle holders 102. Owing to the presence of the foreign matter, the reticle 101 is inclined with respect to the plane perpendicular to the optical axis direction of the optical system.

Hereinafter, the term “tilt angle” in this embodiment means an inclined angle of the reticle 101 with respect to the plane perpendicular to the optical axis direction of the optical system. In addition, the term “foreign matter” means, for example, what is stuck between the reticle 101 and the reticle holders 102 at a time of reticle exchange in a step of forming a pattern on a wafer when a semiconductor device is manufactured. The tilt angle changes depending on size or elastic properties of the foreign matter, position where the foreign matter is stuck, and the like.

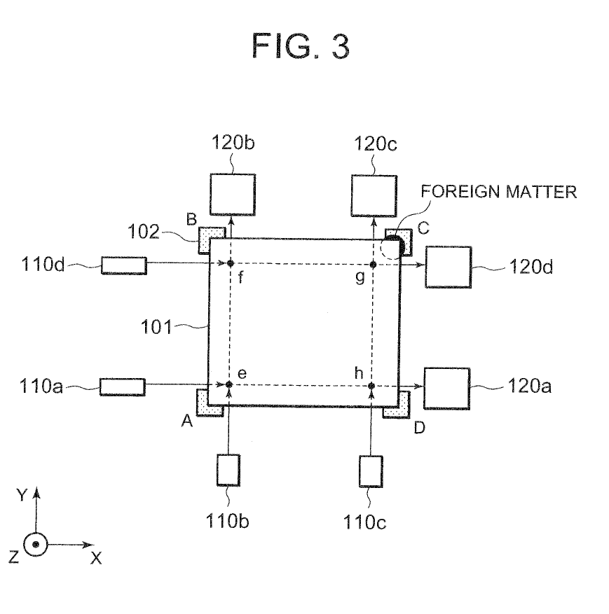

As shown in FIG. 3, the XY plane of the reticle 101 is a square having vertexes A to D. The light-emitting devices 110 and the light-receiving devices 120 are arranged so as to make pairs with respect to respective sides of the square. In other words, on the XY plane of the reticle 101, a light-emitting device 110a and a light-receiving device 120a are arranged so as to sandwich a side AD therebetween, a light-emitting device 110b and a light-receiving device 120b are arranged so as to sandwich a side AB therebetween, a light-emitting device 110c and a light-receiving device 120c are arranged so as to sandwich a side DC therebetween, and a light-emitting device 110d and a light-receiving device 120d are arranged so as to sandwich a side BC therebetween.

The light-emitting devices 110 emit a determining light to an arbitrary point of the reticle 101. The light-receiving devices 120 receive a reflected light which is the determining light reflected on the arbitrary point of the reticle 101. The light-receiving devices 120 may be movable. With this structure, the light-receiving devices 120 are moved to receive the reflected light according to the tilt angle of the reticle 101.

The control device 150 is connected to the light-emitting devices 110 and the light-receiving devices 120 (FIG. 1).

The control device 150 determines the tilt angle of the reticle 101, based on signals transmitted from the light-receiving devices 120, with a reflected light that the light-receiving devices 120 receive before the reticle 101 is inclined, and the reflected light that the light-receiving devices 120 receive when the reticle 101 is inclined.

As described above, the light-emitting devices 110, the light-receiving devices 120, and the control device 150 serve as determining sections for determining tilt angles of the respective sides of the reticle 101.

The control device 150 includes a storing section for storing in advance the reflected light that the light-receiving devices 120 receive before the reticle 101 is inclined. With this structure, tilt angle determination can be automatically performed based on the signals transmitted from the light-receiving devices 120. Further, the control device 150 includes a calculating section, which can calculate a floating amount of the reticle 101 on each vertex thereof based on the determined tilt angle of the reticle 110. Based on the calculated floating amount, an operation of the wafer stage 131 can be controlled to adjust an inclined angle of the wafer 130. Accordingly, positioning of the wafer 130 can be automated. Note that the “floating amount” is described below.

The wafer stage 131 is connected to the control device 150. The tilt angle of the reticle 101 is transmitted from the control device 150 to the wafer stage 131, and the adjusting section included in the wafer stage 131 adjusts the position of the wafer 130 based on the transmitted tilt angle.

The wafer 130 is arranged on the wafer stage 131, and the image surface 140 is formed on the wafer 130. The wafer stage 131 includes the adjusting section.

The adjusting section has a function of adjusting the surface of the wafer 130 so as to be parallel to a surface of the reticle 101, which is perpendicular to the optical axis direction of the optical system, according to the tilt angle determined by the determining section. Accordingly, the focus of the pattern (image surface 140) formed on the surface of the wafer 130 can be adjusted, even when the reticle 101 is inclined.

Note that, in this embodiment, the “positioning” means an adjustment including one of a surface adjustment and an angle adjustment or both of the adjustments. The surface adjustment is a movable adjustment in three axial directions, and the angle adjustment is a rotatably movable adjustment about the axis. With regard to the exposure equipment 100 of this embodiment, the positioning of the wafer 130 is described on the case of the angle adjustment which is performed by rotational movement about the optical axis.

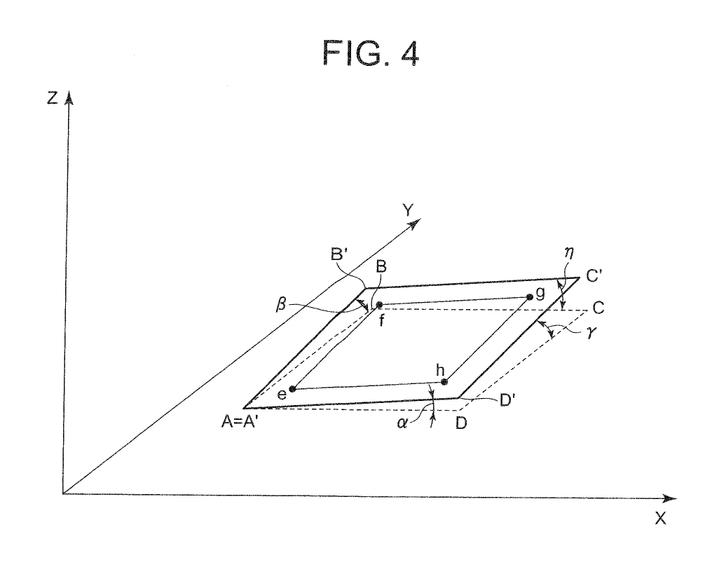

FIG. 4 is a conceptual view for explaining the reticle 101 of the exposure equipment 100 where the foreign matter is stuck in the vicinity of the vertex C, and the position of the reticle 101 is shown by using the axes of X, Y, and Z. The XY plane of the reticle 101 is a square where each side thereof has a length L. The respective vertexes of the XY plane of the reticle 101 which are obtained before the foreign matter is stuck are denoted by A, B, C, and D. Respective vertexes of the XY plane of the reticle 101 which is inclined because of the stuck foreign matter are denoted by A′, B′, C′, and D′. In FIG. 4, the foreign matter is stuck in the vicinity of the vertex C of the XY plane of the reticle 101 and the vertexes B, C, and D are floating, taking the vertex A as a supporting point. A side A′D′ is obtained when the side AD is inclined with respect to an X axis direction by an angle α. A side A′B′ is obtained when the side AB is inclined with respect to a Y axis direction by an angle β. A side D′C′ is obtained when the side DC is inclined from the Y axis direction of the vertex D′ by an angle γ. A side B′C′ is obtained when the side BC is inclined from the X axis direction of the vertex B′ by an angle η.

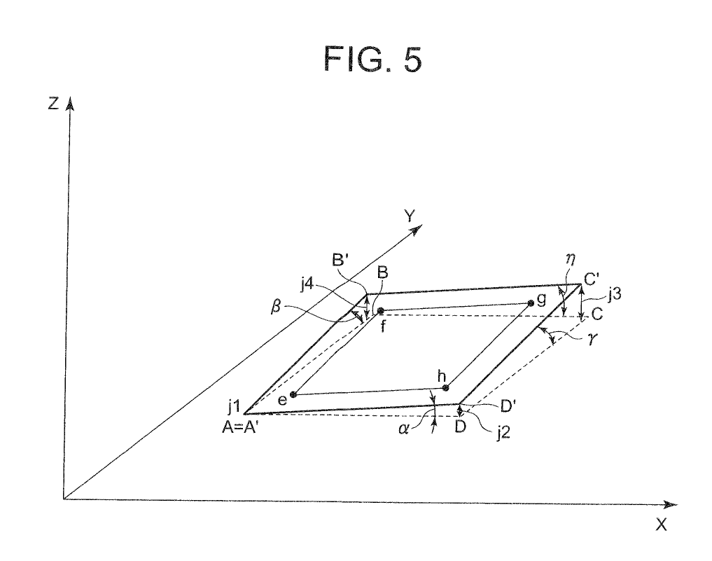

With reference to FIG. 5, the floating amounts for the vertexes B, C, and D of the XY plane of the reticle 101 are described, the vertexes being floating as shown in FIG. 4.

In this embodiment, the “floating amount” is a variation of each of the vertexes of the reticle 101 with respect to a Z axis direction. In other words, the “floating amount” is a difference between each of the vertexes A′, B′, C′, and D′ and each of the vertexes A, B, C, and D, respectively, in the Z axis direction. As shown in FIG. 5, each floating amount of the vertexes A, B, C, and D is represented by j1, j4, j3, and j2, respectively. The vertex A is the supporting point, so A=A′ is established, and the floating amount j1 thereof is zero.

Next, a determining method for the tilt angle and a calculating method for the floating amount are described.

As shown in FIG. 3, points e, f, g, and h are shown in the vicinities of the vertexes A, B, C, and D of the reticle 101, respectively. In this embodiment, the “vicinity” means a state where there is no error generated when the tilt angle of the reticle 101 is determined, comparing a case where the light-emitting devices 110 emit light to the points e, f, g, and h and a case where the light-emitting devices 110 emit light to the vertexes A, B, C, and D. The positions of the points e, f, g, and h are adjustable as needed. The light-emitting devices 110a, 110b, 110c, and 110d emit the determining light to the points e, e, h, and f, respectively. The light-receiving devices 120a, 120b, 120c, and 120d receive the reflected light from the points e, e, h, and f, respectively. Even when the reticle 101 is inclined, the light-emitting devices 110 can emit the determining light to the points e, e, h, and f, and the light-receiving devices 120 can receive the reflected light therefrom.

The angle α is determined as follows.

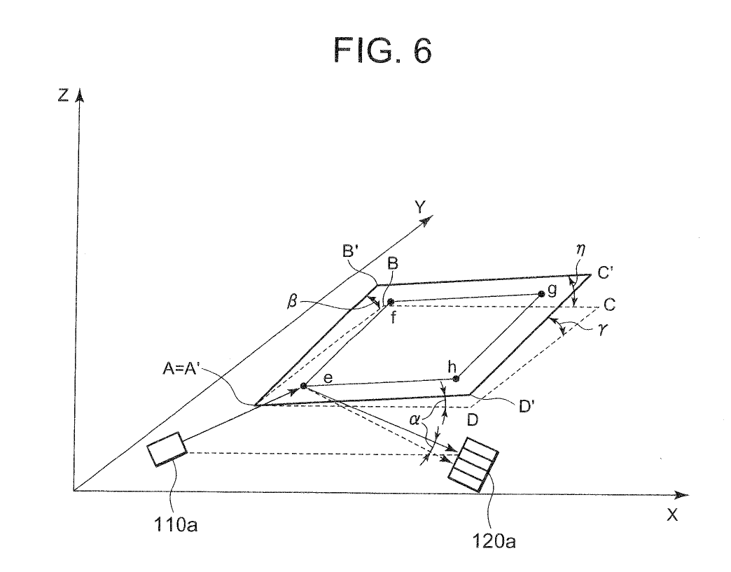

As shown in FIGS. 3 and 6, the light-emitting device 110a and the light-receiving device 120a are arranged parallel to the X axis. The light-emitting device 110a emits the determining light to the point e of the reticle 101, and the light-receiving device 120a receives the reflected light that is reflected on the point e.

FIG. 6 shows the reflected light that the light-emitting device 110a emits and that is reflected on the point e on the reticle 101. The reflected light that is reflected before the reticle 101 is inclined (in a horizontal state) is shown with a solid line, and the reflected light that is reflected on the point e of the inclined reticle 101 is shown with a dashed line. Comparison between the reflected light in the horizontal state and the reflected light of the inclined reticle 101 is performed to determine the tilt angle α. Note that, although not shown in FIG. 6, the light-emitting device 110a can emit the determining light to the point e on the reticle 101 even when the reticle 101 is inclined.

Subsequently, the floating amount j2 is calculated as follows.

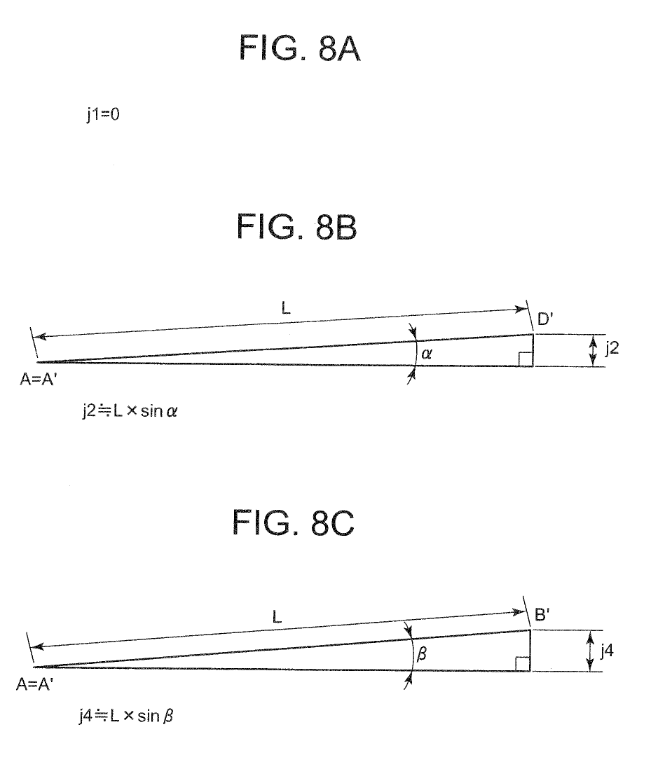

FIGS. 8A to 8C are conceptual views for explaining a calculating method for a floating amount as shown in FIG. 5. With respect to the tilt angle α determined as described above, the floating amount j2 can be calculated geometrically and approximately by Expression (1) below.

j2≈L×sin α (1)

As described above, the tilt angle α is determined, and the floating amount j2 is calculated.

The angle β is determined as follows.

As shown in FIG. 3, the light-emitting device 110b and the light-receiving device 120b are arranged parallel to the Y axis. Similarly as described above, the light-emitting device 110b emits the determining light to the point e of the reticle 101, and the light-receiving device 120b receives the reflected light that is reflected on the point e. Similarly as described above, comparison between the reflected light in the horizontal state and the reflected light of the inclined reticle 101 is performed to determine the tilt angle β.

Subsequently, the floating amount j4 is calculated as follows.

FIGS. 8A to 8C are conceptual views for explaining the calculating method for a floating amount as shown in FIG. 5. With respect to the tilt angle β determined as described above, the floating amount j4 can be calculated geometrically and approximately by Expression (2) below.

j4≈L×sin β (2)

As described above, the tilt angle β is determined, and the floating amount j4 is calculated.

Next, the angle γ is determined as follows.

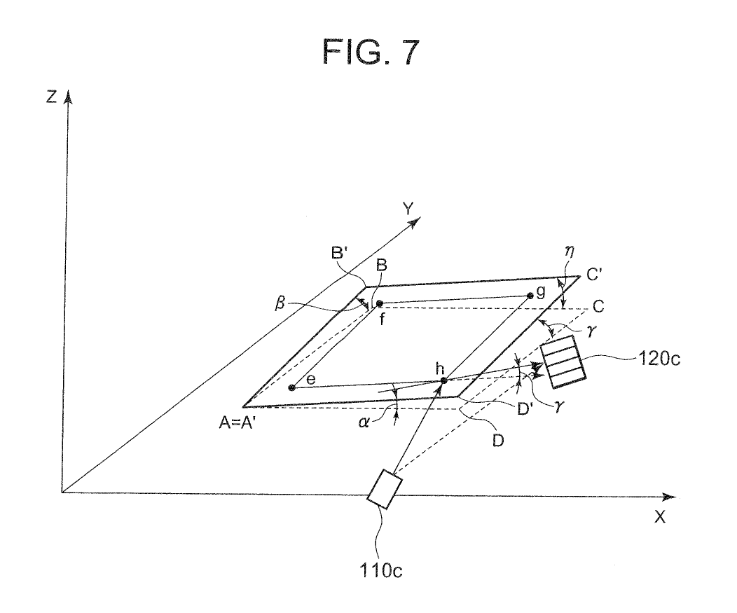

As shown in FIGS. 3 and 7, the light-emitting device 110c and the light-receiving device 120c are arranged parallel to the Y axis. Similarly as described above, the light-emitting device 110c emits the determining light to the point h of the reticle 101, and the light-receiving device 120c receives the reflected light that is reflected on the point h.

FIG. 7 shows the reflected light that the light-emitting device 110c emits and that is reflected on the point h on the reticle 101. The reflected light that is reflected before the reticle 101 is inclined (in the horizontal state) is shown with a solid line, and the reflected light that is reflected on the point h of the inclined reticle 101 is shown with a dashed line. Comparison between the reflected light in the horizontal state and the reflected light of the inclined reticle 101 is performed to determine the tilt angle γ. Note that, although not shown in FIG. 7, the light-emitting device 110c can emit the determining light to the point h on the reticle 101 even when the reticle 101 is inclined.

Subsequently, the floating amount j3 is calculated as follows.

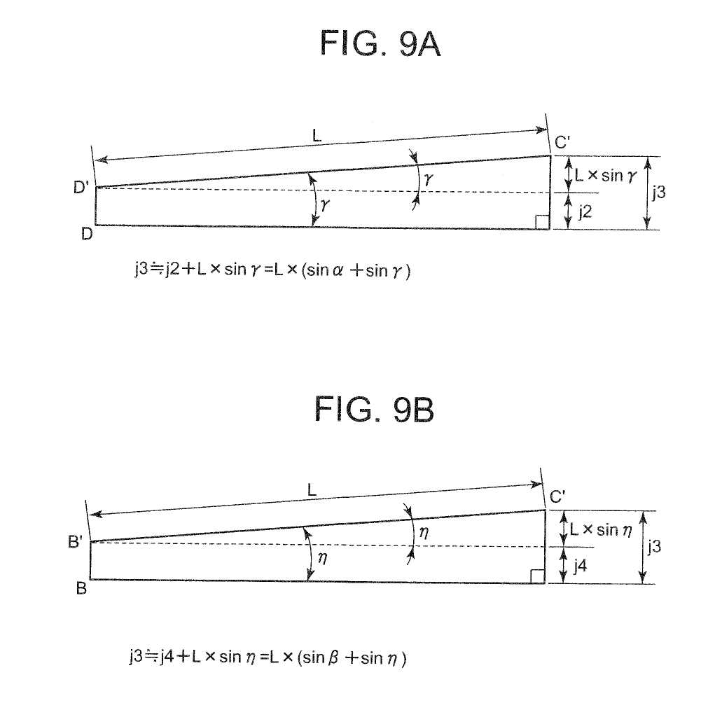

FIGS. 9A and 9B are conceptual views for explaining the calculating method for a floating amount as shown in FIG. 5. With respect to the tilt angle γ determined as described above, the floating amount j3 can be calculated geometrically and approximately by Expression (3) below.

j3≈j2+L×sin γ=L×(sin α+sin γ) (3)

As described above, the tilt angle γ is determined, and the floating amount j3 is calculated.

The angle η is determined as follows.

As shown in FIG. 3, the light-emitting device 110d and the light-receiving device 120d are arranged parallel to the X axis. Similarly as described above, the light-emitting device 110d emits the determining light to the point f of the reticle 101, and the light-receiving device 120d receives the reflected light that is reflected on the point f. Comparison between the reflected light in the horizontal state and the reflected light of the inclined reticle 101 is performed to determine the tilt angle η.

Subsequently, the floating amount j3 is calculated as follows.

FIGS. 9A and 9B are conceptual views for explaining the calculating method for a floating amount as shown in FIG. 5. With respect to the tilt angle η determined as described above, the floating amount j3 can be calculated geometrically and approximately by Expression (4) below.

j3≈j4+L×sin η=L×(sin β+sin η) (4)

As described above, the tilt angle η is determined, and the floating amount j3 is calculated.

In the above, the floating amount j3 can be calculated by Expressions (3) and (4) Further, actually, it is considered that a slight difference between the floating amount j3 obtained by Expression (3) and the floating amount j3 obtained by Expression (4) exists due to determining errors. Therefore, it is preferable to determine a final floating amount j3 through statistical processing such as equation of the floating amount j3 (by the use of Expression (3)) with the floating amount j3 (by the use of Expression (4)), which are obtained through multiple determinations.

With the aforementioned procedure, the tilt angle of the reticle 101 with respect to the plane perpendicular to the optical axis direction of the optical system is determined. In other words, the tilt angle of the XY plane of the reticle 101 in the exposure equipment 100 is defined by the floating amounts j2, j4, j3, and j1 (=0). Based on the tilt angle defined by the floating amounts j2, j4, j3, and j1 (=0), the exposure equipment 100 inclines the wafer stage 131 thereof to adjust the positions of the wafer 130 and the image surface 140, whereby the surface of the wafer 130 and the surface of the reticle 101, which is perpendicular to the optical axis direction of the optical system, are parallel to each other. As a result, even when the reticle 101 is inclined, a shift of the focus caused on the image surface 140 is reduced. That is, a shift of the focus caused on the wafer 130 at a time of performing a projection exposure can be reduced in the entire shot area.

The exposure method according to the exposure equipment 100 includes the step of projecting on the wafer 130 the pattern 170 formed on the surface of the reticle 101, the step of determining a tilt angle of the reticle 101 with respect to the optical axis direction of the optical system, and the step of adjusting the surface of the wafer 130 so as to be parallel to the surface of the reticle 101, which is perpendicular to the optical axis direction of the optical system, based on the determined tilt angle.

The exposure light emitted from the optical system passes through the reticle 101 and the reduction-projection lens 160 to project on the wafer 130 (target of exposure) the pattern 170 formed on the surface of the reticle 110. For the projection, a publicly known method can be used. Further, the step of determining a tilt angle and the step of adjusting the same are performed as described above.

The advantages of the exposure equipment 100 are described below.

In the case where a foreign matter is stuck between the reticle 101 and the reticle holders 102, and the reticle 101 is inclined, the exposure equipment 100 directly determines the tilt angle of the reticle 101. Then, the exposure equipment 100 controls the operation of the wafer stage 131 based on the determined tilt angle, and adjusts the position of the wafer 130, thereby adjusting the focus on the wafer 130. Therefore, even when a reticle normally used is employed irrespective of the type of reticle, the focus on the wafer 130 can be adjusted with ease, and a pattern having high resolution can be obtained. Moreover, it is unnecessary to perform a troublesome operation such as using a wafer having a satisfactory flatness, thereby enabling successive processes (in-line process) Specifically, while being taken into consideration the productivity and advantages, the determination of the tilt angle and the calculation of the floating amount are performed for each shot, for each series of shots, or for each reticle set. As a result, the image surface 140 on which the focus has been adjusted on the entire shot area can be formed on the surface of the wafer 130 by the successive processes (in-line process).

With the exposure equipment 100, a pattern can be formed on the wafer 130 to manufacture a semiconductor device. Publicly known methods are employed for steps other than the step of forming a pattern on the wafer 130. As a result, a manufacturing method for a semiconductor device having high productivity can be attained.

The exposure equipment and the exposure method according to the present invention are not limited to the aforementioned embodiment, and various modifications thereof can be performed.

For example, in the above-mentioned embodiment, the case where the reticle 101 is a square is described, but the present invention is not limited thereto. For example, the reticle 101 may be a rectangle, polygon, or circle. Further, the case where the four pairs of the light-emitting devices 110 and the light-receiving devices 120 are employed is described, but the present invention is not limited thereto. Five or more pairs of the light-emitting device and the light-receiving device may be employed.

Further, in the above-mentioned embodiment, the case where the foreign matter is stuck in the vicinity of the vertex C of the reticle 101 is described, but the position and the number of the vertexes where the foreign matter is stuck are not limited thereto. In the embodiment of the present invention, the case where the vertex A is the supporting point is described, but there may be cases where all of the four vertexes maybe floating, or where the vertexes A and B may be taken as supporting points, and the vertexes C and D may be floating. Similarly, the position of supporting point, and the positions and the number of floating vertexes are not limited thereto. The number of the light-emitting devices 110 and the light-receiving devices 120, and installation locations thereof can be suitably set so that, even when a foreign matter is stuck in any vertex of the reticle 101, the tilt angle and the floating amount of the reticle 101 can be obtained with the similar principle.

What is claimed is:

1. An exposure equipment, comprising:
an optical system for projecting, on a wafer, a pattern formed on a surface of a reticle;
a determining section for determining a tilt angle of the reticle with respect to a plane perpendicular to an optical axis direction of the optical system; and
a wafer stage for holding the wafer.

2. The exposure equipment according to claim 1, further comprising an adjusting section for adjusting a position of the wafer on the wafer stage based on the tilt angle determined by the determining section.

3. The exposure equipment according to claim 2, wherein the adjusting section adjusts a surface of the wafer to be parallel to the surface of the reticle, which is perpendicular to the optical axis direction of the optical system, based on the tilt angle determined by the determining section.

4. The exposure equipment according to claim 1, wherein the determining section comprises a light-emitting device for emitting light to the reticle and a light-receiving device for receiving the light reflected on the reticle.

5. The exposure equipment according to claim 4, wherein the determining section comprises at least four pairs of the light-emitting device and the light-receiving device.

6. The exposure equipment according to claim 4, wherein the light-receiving device is movable.

7. The exposure equipment according to claim 1, further comprising a storing section for storing the tilt angle determined by the determining section.

8. An exposure method, comprising:
determining a tilt angle of a reticle with respect to a plane perpendicular to an optical axis direction of an optical system;
adjusting a surface of a wafer to be parallel to a surface of the reticle, which is perpendicular to the optical axis direction of the optical system, based on the determined tilt angle; and
projecting, on the wafer, a pattern formed on the surface of the reticle.

9. The exposure method according to claim 8, wherein the determining a tilt angle comprises emitting light to the reticle and receiving the light reflected on the reticle.

10. The exposure method according to claim 9, wherein the emitting light to the reticle and receiving the light reflected on the reticle is performed on at least four points on the reticle.

11. A manufacturing method for a semiconductor device, comprising forming a pattern on a wafer by using the exposure equipment according to claim 1.
